(19) United States
(12) Patent Application Publication
(10) Pub. No.: US 2008/0066545 A1
(43) Pub. Date: Mar. 20, 2008

(54) Speed measuring device

(76) Inventor: Scott Brundage, Las Vegas, NV (US)

Correspondence Address: ROBERT RYAN MORISHITA;MORISHITA LAW FIRM, LLC, 3800 HOWARD HUGHES PKWY,, SUITE 850, LAS VEGAS, NV, 89169, US

(21) Appl. No.: 11/605,578

(22) Filed: Nov. 27, 2006

Related U.S. Application Data
(63) Continuation-in-part of application No. 10/383,817, filed on Mar. 6, 2003, now Pat. No. 7,140,248.
Application No. 10/383,817 is a continuation-in-part of application No. 10/350,251, filed on Jan. 22, 2003, now abandoned.
(60) Provisional application No. 60/351,478, filed on Jan. 22, 2002.

(51) Int. Cl. G01P 3/44; G01P 1/10; A63B 71/06

(52) U.S. Cl. 73/494; 702/145; 473/234

(57) ABSTRACT

A device is mounted to a support, optionally a wearable support such as a glove, watch, wrist or arm band, or the like. Alternatively, the support is incorporated into a sports club or is a removable attachment for a sports club. The device includes a speed measuring device, such as a velocimeter or accelerometer, a data processor, a data storage, a power supply, and an output device for visually, aurally, or electrically outputting the calculated speed.

### RELATED APPLICATION DATA

The present application is a continuation-in-part of U.S. application Ser. No. 10/383,817 entitled “Speed Measuring Device and Method” filed Mar. 6, 2003 by Applicant herein and issued as U.S. Pat. No. 7,140,248 on Nov. 28, 2006, which, in turn is a continuation-in-part of U.S. application Ser. No. 10/350,251 entitled “Speed Measuring Device and Method” filed Jan. 22, 2003 by Applicant herein and now abandoned, which, in turn, claimed the priority of U.S. Provisional Application Ser. No. 60/351,478 entitled “Speed Measuring Device” filed Jan. 22, 2002 by Applicant herein.

### FIELD OF THE INVENTION

The present invention relates to speed measuring devices. Specifically, the present device is a speed measuring device for measuring the speed of a sport player's movements.

### BACKGROUND OF THE INVENTION

There are many devices known in the art for measuring a sports player's performance during training and competition. Moreover, it is well known to utilize such devices in conjunction with a training regimen to increase strength and body speed. For example, as explained in my prior U.S. Pat. No. 6,280,353 the use of weighted clubs or bats in conjunction with a speed measuring device to achieve a desired club or bat speed can aid a player in increasing the speed with which a ball is struck. As can be appreciated, this result is advantageous in many sports including baseball, softball, golf, tennis, and the like.

Similarly, Cobb, U.S. Pat. No. 4,759,219 discloses the use of a force transducer generating pulses to discern the relative centripetal velocity of a baseball bat. However, the drawback to Cobb, and many other velocimeters and accelerometers, are that the force transducers used can be disrupted by the impact of the club or bat against a ball. Thus, an erroneous reading can result from the use of such a force transducer to measure a velocity when hitting a ball.

### SUMMARY OF THE INVENTION

A device for measuring the speed of a user's motion includes a speed measuring device that measures speed, optionally in a continuous manner, and generates a signal corresponding to the speed. The speed measuring device could take many forms including a velocimeter. In an optional embodiment, the speed measuring device is an accelerometer, including a force transducer, communicating with a data processor. In such an optional embodiment, the force transducer measures the centripetal force. The data processor samples the centripetal force measurements. The data processor calculates the speed of the user's motion using one or more of the centripetal force measurements. In an embodiment in which the path of the user's motion is arcuate, a fixed approximation of the radius of motion stored at a data storage or an input radius received at an input device communicating with the data processor may also be used to calculate speed.

The speed measuring device is carried along the path of the user's motion by a support. It is contemplated that the support may be incorporated into a sports club, such as a baseball bat, tennis racket, golf club, or the like, or removably attached to a sports club. For example, in one optional embodiment, the support is an annular ring that surrounds and attaches to the body of a sports club such as a baseball bat. Alternatively, the support could be a wearable support that attaches to the user's body or clothing. The wearable support may take many forms including a strap, glove, watch, wrist or arm band, or the like.

An output device also communicates with the speed measuring device. The data processor generates a signal corresponding to the speed for output at the output device. The output device may take the form of a display, annunciator, or an output to another device, such as a computer, for recording and/or analysis. In one optional embodiment in which the output device is an annunciator, the output of the calculated speed may occur by the data processor selecting a sound file corresponding to a calculated speed from the data storage and transmitting that sound file to an annunciator at the output device for output as an audible verbal announcement. In a further optional embodiment, the data storage may store auxiliary sound files that correspond to tips, suggestions, encouraging messages, or the like. In one such optional embodiment, the data processor randomly selects an auxiliary sound file and transmits the auxiliary sound file to the annunciator for output as an audible verbal signal.

The device of the present invention is powered by a power source communicating with the speed measuring device. The power source may take the form of a conventional electrical cell or battery or may use the motion of the wearer to generate power using mechanical, electrical, or piezoelectric means. The power source may be controlled and actuated by a switch. Optionally the switch is of a type that only actuates the power source when the switch is in motion.

In use, the support is secured to the player's body or an object associated with the motion to be measured. The player performs the motion in a manner consistent with the associated sport or activity, such as baseball, softball, golf, tennis, boxing, or the like. The speed measuring device measures the speed of the player's motion and transmits a signal to a data processor which, in turn, transmits a signal to the output device for output.

For example, in an optional embodiment including an accelerometer and processor, the accelerometer measures the centripetal force and the processor samples the measurements received. Using the measurements sampled and either a fixed radius or an input radius, the processor determines the speed of the user's motion and transmits data indicating speed to the output device.

If more than one centripetal force measurement is sampled from the accelerometer, further data processing may be performed by the data processor. For example, if more than one centripetal force measurement is sampled from the accelerometer, the data processor may optionally select the greatest centripetal force measurement in determining the speed of the user's motion. Similarly, if the user's motion includes an impact, the data processor may sample centripetal force measurements from the accelerometer at predetermined intervals and select a centripetal force measurement prior to the impact, optionally immediately preceding the impact, to determine the speed of the user's motion. Likewise, the processor may store or otherwise retain one or more sets of measurements for statistical analysis and/or comparison of one set of data to another set of data.

### BRIEF DESCRIPTION OF THE DRAWINGS

FIG. 1 is a top assembly view of a support and speed measuring device according to an embodiment of the present invention;

FIG. 2 is a side view of a support and speed measuring device according to an alternate embodiment of the present invention;

FIG. 3 is a block diagram of a speed measuring device according to an embodiment of the present invention;

FIG. 4 is a flowchart of a method for measuring speed according to an embodiment of the present invention.

### DESCRIPTION

Reference is now made to the figures wherein like parts are referred to by like numerals throughout. The present invention is directed to a device for measuring the speed of a user's motion. It is contemplated that the device may have particular application for sports such as tennis, baseball, golf, boxing, and the like.

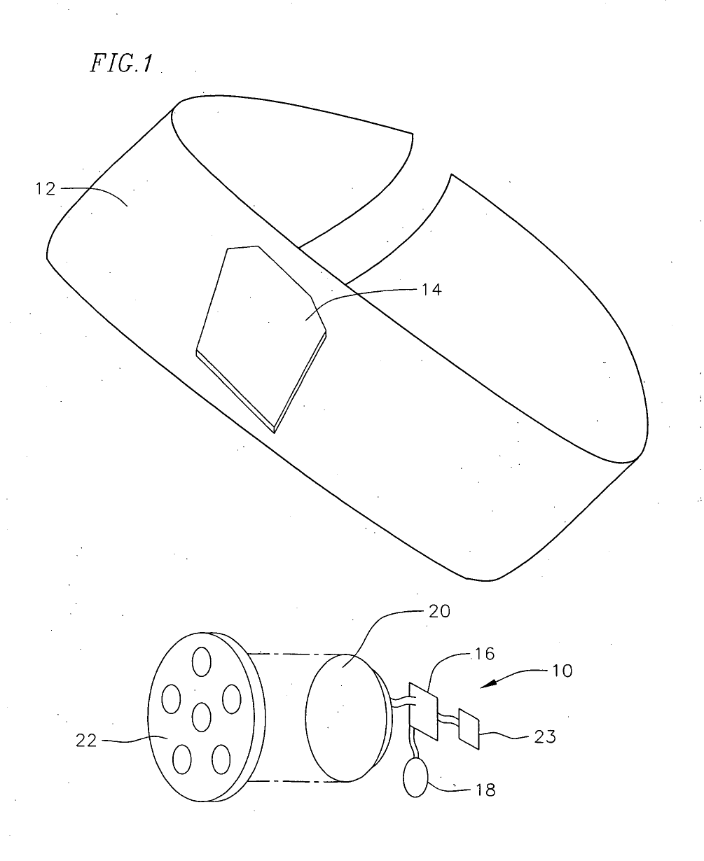

Referring to FIG. 1, the present invention includes a device 10 for measuring speed, optionally continuously, and generating a signal corresponding to the speed mountable to a support. The device 10 includes a speed measuring device 16, such as an accelerometer or velocimeter, communicating with a data processor 23, such as that described in greater detail below. In an optional embodiment, the data processor 23 may communicate with data storage 31 for storing data.

The support may take the form of a sports club, such as a baseball bat, tennis racket, golf club, or the like. In a further embodiment, the support may be a training sports bat such as that shown in my U.S. Pat. No. 6,280,353. In such an embodiment, the speed measuring device 10 is mounted to the sports club or mounted in a compartment in the sports club.

In one optional embodiment, a wearable support 12 is provided. The wearable support 12 may take many forms including that of a glove, watch, wrist or arm band, or the like. For example, the embodiment of FIG. 1 shows a wearable support 12 in the form of a glove. The wearable support 12 includes a compartment or mount for holding the speed measuring device 10. For example, in the embodiment of FIG. 1, a pocket 14 is provided for the device 10. Optionally, the pocket 14 includes a fastener, such as a hook and pile fastener, for closing the pocket 14.

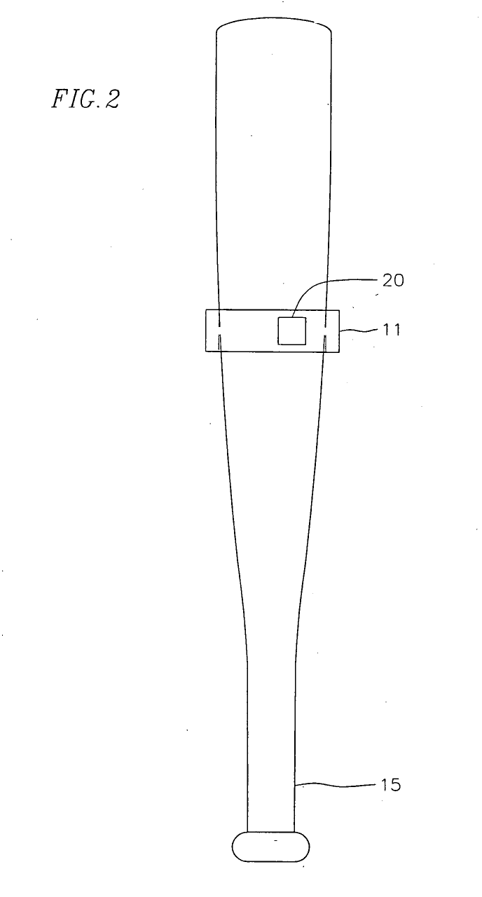

In the alternate embodiment of FIG. 2, the support is a sports club or an attachment to a sports club. More specifically, as shown in the optional embodiment of FIG. 2, the support may be an annular ring 11 that encircles the body of a sports club; in this optional embodiment, the sports club is a baseball bat 15. While there could be an active fastener securing the support to the sports club, in the optional embodiment of FIG. 2, the annular ring 11 is held on the sports club using a friction fit.

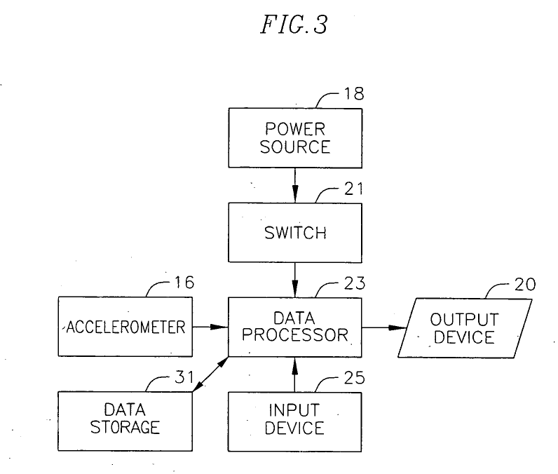

Referring generally to FIGS. 1-3, as stated above, the device 10 includes a speed measuring device 16, such as a velocimeter or accelerometer, measuring the speed of a discrete motion. In an optional embodiment in which an accelerometer 16 is used, shown in FIG. 3, the accelerometer includes a force transducer. In a case where the user's motion follows an arcuate path with a radius of motion, the force transducer measures the centripetal force on the accelerometer and generates a signal corresponding to the centripetal force. The data processor 23 samples the centripetal force signal from the accelerometer and determines the speed of the motion. Optionally, the force transducer, alone or with other force transducers, may also indicate the orientation and/or direction of the motion.

The centripetal force is proportional to the velocity of the motion. In an optional embodiment, the data processor 23 uses the sampled centripetal force measurement and a radius of motion to calculate a speed. In one optional embodiment, a fixed estimate corresponding to the radius of motion is stored in the data storage 31. That is, in such an optional embodiment, the radius is treated as a constant value. Alternatively, an input device 25, such as a button, dial, keypad, or the like, may be provided to receive an input radius. Such an embodiment may be suited for a wearable support so that the device could be used in conjunction with a number of different sports clubs. For example, using the flexibility afforded by the input radius, the same device could accurately measure the speed of different clubs, for example a baseball bat and a golf club, by merely entering the relative lengths of the clubs.

In an optional embodiment including a data storage 31 communicating with the data processor 23, the data storage 31 may optionally store speeds calculated. It is contemplated that many different criteria could be used in determining which speeds are stored at the data storage 31. For example, the most recent set of speeds could be stored, with newer speeds replacing older speeds in sequence. In another optional embodiment, a user could selectively store speeds. In yet another optional embodiment, the data storage 31 may store the highest or lowest speeds over a selected number of trials or a selected time period. In other words, the set of stored speeds could be determined by selectively storing or discarding speeds depending on any of a number of possible criteria including the sequence of the speeds, the absolute size of the speeds the relative size of the speeds, or the like.

Further data manipulation may also take place based on one or more of the calculated speeds stored. For example, the data processor 23 may calculate and output the mean speed for a series of trials, the highest and lowest speeds for a series of trials, trends over a series of trials, or other statistical calculations based on the raw speed measurements or the calculated speeds.

Turning back to FIGS. 1 and 2, the device 10 further includes a power source 18 connected to, and powering, the data processor 23. In an optional embodiment, the same power source 18 may power both the speed measuring device 16 and data processor 23. The power source 18 could take any form including an electrical or chemical cell, i.e. a battery, or it could be a mechanical, electrical, or piezoelectric device for translating the motion of the user to electrical energy. Further, a switch 21 could be provided. A switch could take many forms but in an optional embodiment, the switch 21 actuates the power source 18 to power the speed measuring device 16 and data processor 23 when the switch 21 is moving.

An output device 20 is included in the device 10. In an embodiment including a data processor 23, the output device communicates with the data processor 23. The output device 20 could output the speed from the processor 23 in a visual, aural, or computer-readable fashion. That is, the output device 20 could optionally be a display for visually displaying the speed in text or graphic form, an annunciator for generating an audible verbal announcement of a speed, a communication device (optionally wired or wireless) for transmitting the speed from the device 10 to an external device. In the latter optional embodiment, the output could be transmitted through a wire or via radio transmission to one or more external devices such as a personal data assistant (“PDA”), general purpose computer, specific purpose computer, or the like for display, recording and/or analysis. Optionally, the speed measuring device 16, power source 18, data processor 23, and output device 20 are housed in a housing 22.

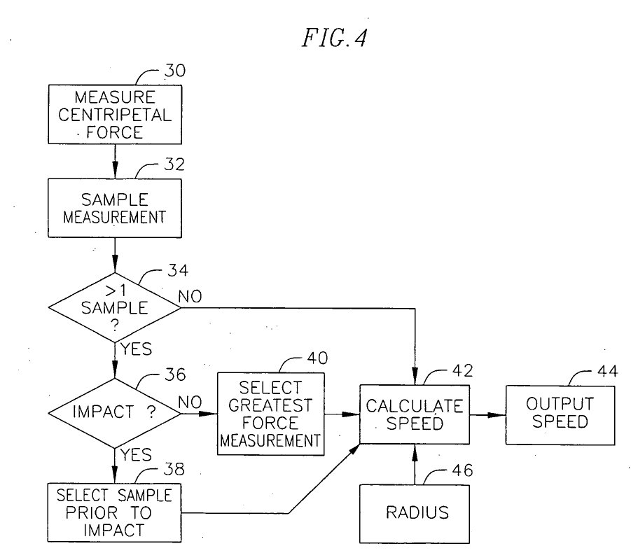

An optional embodiment of a method according to the present invention is shown in FIG. 4. Referring first to an embodiment in which the device 10 is mounted, removably or permanently, to the sports bat, club, or racket, in use, the user simply swings the sports bat, club, racket, or the like. The speed measuring device 16 measures the speed of the swing and communicates the measurement to the processor 23. As discussed above, the speed measuring device 16 could take the form of an accelerometer measuring 30 a centripetal force. In one such optional embodiment, a data processor 23 samples 32 the centripetal force measurements from the accelerometer 16. The data processor 23 calculates 42 the speed of the user's motion using a radius 46 in the form of a fixed radius stored at a data storage 31 or a radius input at an input device 25.

The data processor 23 outputs the calculated speed through an output device 20. The output device 20 outputs 44 the speed by, for example, displaying the speed, announcing the speed, or electrically transmitting the speed. As noted above, in one optional embodiment, sound files that correspond to calculated speeds are stored at a data storage 31. In one such optional embodiment, the data processor 23 selects a sound file associated with the calculated speed and outputs the sound file as an audible verbal announcement of the speed through the output device 20, in this case an annunciator.

In an optional embodiment, the data storage 31 also stores a auxiliary sound files. The auxiliary sound files may be sound effects, such as a ball hitting a sport club, or audible verbal announcements. In one such optional embodiment, the auxiliary sound files are output with the sound files associated with a speed. In one optional embodiment, an auxiliary sound file is associated with a measurement associated with the motion. For example, in one optional embodiment, the data processor may communicate with an orientation measuring device and the auxiliary sound file may be selected to tell the player the direction of the swing or the result of the swing, e.g. “fly ball,” “grounder,” or the like. In another optional embodiment, the auxiliary sound files are associated with tips, e.g. “keep your head down,” encouragement, e.g. “good swing,” or the like and are randomly selected.

To repeat use, an optional reset button (not shown) may be used to clear the speed measurement or, in an alternate optional embodiment, the user simply swings again.

Referring to an embodiment in which the speed measuring device 10 is mounted to a wearable support 12, the user secures the speed measuring device 10 to the wearable support 12. As discussed above, this mounting may simply be the user inserting the device 10 into a pocket 14 on a strap or band such as that shown in FIG. 1. The user wears the wearable support 12 on the body part intended to be in motion during the motion. The user performs the motion associated with the sport or activity, such as swinging a baseball bat, swinging a racket, swinging a golf club, punching, or the like. Again, the device 10 measures the speed and communicates the measurement through the output device 20. The output device 20 outputs the measurement in a manner previously discussed.

In the situation in which more than one measurement is sampled 34 by the data processor 23 from the speed measuring device 16, the data processor 23 may optionally select 40 the greatest measurement to calculate the speed. Since the speed is directly proportional to the centripetal force, the greatest measurement corresponds to the maximum speed attained during the discrete motion.

In an other optional embodiment in which the user's motion includes an impact 36, such as when hitting a ball, the data processor 23 may sample centripetal force measurements from the accelerometer at predetemined intervals. The data processor 23 then selects 38 a centripetal force measurement prior to the impact. Optionally, the data processor 23 selects a centripetal force measurement immediately preceding the impact. The data processor 23 could determine the instant of impact by looking for a sudden change in centripetal force as the energy of the swing is transferred through the impact. In an optional embodiment of the invention, the data processor 23 may also determine the effect of the impact on the object struck based upon the relative time of the impact during the user's motion. In one such optional embodiment, an auxiliary sound file may be selected based on that determination to output an audible verbal announcement informing the user of the effect, e.g. “hit to the opposite field,” or “ball pulled down the left field line.”

While certain embodiments of the present invention have been shown and described it is to be understood that the present invention is subject to many modifications and changes without departing from the spirit and scope of the invention presented herein.

I claim:

1. A device for measuring the speed of a user's motion in an arcuate path with a radius of motion, comprising:
a speed measuring device adapted to generate a signal corresponding to said motion;
a data processor in communication with said speed measuring device;
a data storage in communication with said data processor, said data storage storing at least a radius of motion and a plurality of sound files each corresponding to a speed;
a support adapted to carry said speed measuring device along said path;
an output device in communication with said data processor, said output device including an annunciator adapted to generate an audible verbal signal corresponding to a sound file selected by said data processor from said data storage;
a power source in electrical communication with at least said data processor; and
a switch in electrical communication with said power source, said switch adapted to actuate said power source to power said data processor to calculate a speed of said motion utilizing said signal received from said speed measuring device and a radius of motion stored at said data storage, select a sound file corresponding to said calculated speed, and communicate said sound file to said output device where said annunciator converts said sound file to an audible verbal announcement of said calculated speed.

2. The device of claim 1 wherein said speed measuring device comprises an accelerometer including a force transducer adapted to measure centripetal force and generate a signal corresponding to said centripetal force.

3. The device of claim 1 wherein said data storage further stores at least two of said calculated speeds.

4. The device of claim 1 wherein said data storage further stores a plurality of auxiliary sound files and wherein said data processor is adapted to randomly select an auxiliary sound file and communicate said sound file to said output device where said annunciator converts said auxiliary sound file to an audible verbal announcement.

5. The device of claim 1 further comprising an input device in communication with said data processor, said input device adapted to receive an input radius for storage at said data storage.

6. The device of claim 1 where in said switch is adapted to be activated by said motion.

7. The device of claim 1 wherein said support is an annular ring adapted to be received around the body of a baseball bat.

8. The device of claim 1 wherein said support is a band adapted to be received onto said user's body.

9. The device of claim 1 wherein said support is a glove adapted to be received onto said user's hand.

10. A device for measuring the speed of a user's motion in a first direction, comprising:
an accelerometer including a force transducer;
a data processor in communication with said accelerometer;
a data storage in communication with said data processor, said data storage storing a plurality of sound files each corresponding to a speed;
a support carrying said accelerometer along the path of said user's motion;
an output device in communication with said data processor, said output device including an annunciator adapted to generate an audible verbal signal corresponding to a sound file selected by said data processor from said data storage; and
a power source supplying power to said data processor such that as said accelerometer is carried by said support along said path, said accelerometer continuously measures the centripetal force exerted on the force transducer throughout said motion including during an impact and generates a signal corresponding to the centripetal force, said data processor adapted to sample said signal from said accelerometer including during said impact and calculate the speed of said motion by determining when said impact occurred and selecting a centripetal force measurement prior to said impact, select a sound file associated with said calculated speed, and communicate said sound file to said output device where said annunciator converts said sound file to an audible verbal announcement of said calculated speed.

11. The device of claim 10 wherein said user's motion is arcuate and said data storage further stores a fixed approximation of a radius of said arcuate motion, said data processor adapted to calculate the speed of said motion using said signal corresponding to said centripetal force and said stored approximation of said radius.

12. The device of claim 10 wherein said user's motion is arcuate with a radius of motion, said device further comprising an input device communicating with said processor adapted to receive an input radius corresponding to said radius of motion, such that said data processor is adapted to calculate the speed said motion using said signal corresponding to said centripetal force and said input radius.

13. The device of claim 10 wherein said data storage further stores at least two of said calculated speeds.

14. The device of claim 10 wherein said data storage further stores a plurality of auxiliary sound files and wherein said data processor is adapted to randomly select an auxiliary sound file and communicate said sound file to said output device where said annunciator converts said auxiliary sound file to an audible verbal announcement.

15. The device of claim 10 further comprising a switch communicating with said power source and said data processor, said switch only actuating said power source to power said data processor when said switch is moving.

16. The device of claim 10 wherein said output device further comprises a display.

17. The device of claim 10 wherein said output device farther comprises a communications device adapted to communicate with an external device.

18. The device of claim 17 wherein said communications device is adapted to communicate via radio transmission.
